(19) United States
(12) Patent Application Publication
(10) Pub. No.: US 2018/0201066 A1
(43) Pub. Date: Jul. 19, 2018

(54) HYDROGENATED CONJUGATED DIENE POLYMER AND PRODUCTION METHOD OF THE SAME, POLYMER COMPOSITION, CROSSLINKED POLYMER, AND TIRE

(71) Applicant: JSR CORPORATION, Minato-ku (JP)

(72) Inventors: Takumi ADACHI, Tokyo (JP); Ryoji TANAKA, Tokyo (JP); Takaomi MATSUMOTO, Tokyo (JP); Fumihiro TOYOKAWA, Tokyo (JP); Naoya NOSAKA, Tokyo (JP)

(73) Assignee: JSR CORPORATION, Minato-ku (JP)

(21) Appl. No.: 15/744,225

(22) PCT Filed: Jul. 21, 2016
(86) PCT No.: PCT/JP2016/071444

§ 371 Date: Jan. 12, 2018

(30) Foreign Application Priority Data
Jul. 22, 2015 (JP) 2015-145137

(51) Int. Cl. B60C 1/00; C08K 3/011; C08K 3/34; C08K 5/00; C08L 9/06; C08F 236/10; C08F 8/04; C08F 297/04

(52) U.S. Cl. CPC B60C 1/0016; B60C 1/0025; C08K 3/011; C08K 3/34; C08F 2800/20; C08L 9/06; C08F 236/10; C08F 8/04; C08F 297/04; C08K 5/0025

(57) ABSTRACT

Provided is a hydrogenated conjugated diene polymer which is a hydrogenated product of a conjugated diene polymer having a structural unit derived from a conjugated diene compound and a structural unit derived from an aromatic vinyl compound, wherein the conjugated diene compound includes butadiene, an amount of the structural unit derived from the aromatic vinyl compound is 30 mass % or more with respect to entire structural units derived from monomers of the polymer, and a hydrogenation rate of the structural unit derived from butadiene is 80% to 99%.

### TECHNICAL FIELD

The present disclosure relates to a hydrogenated conjugated diene polymer and a production method of the same, a polymer composition, a crosslinked polymer, and a tire.

### BACKGROUND ART

The copolymers of a conjugated diene compound and an aromatic vinyl compound have been used for various applications such as pneumatic tires and hoses, and vibration damping rubber because of the various satisfactory characteristics such as heat resistance, abrasion resistance, mechanical strength, and molding processability.

Incidentally, in regard to the pneumatic tire, there has been a demand for improvement in fuel economy performance due to increased awareness regarding environmental circumstances such as global warming caused by carbon dioxide emissions, resource conservation, and energy conservation, and economic circumstances such as recent rise in gasoline price. In response to such demand, various conjugated diene rubbers have recently been proposed (for example, see Patent Document 1). Patent Document 1 discloses a conjugated diene rubber having a terminal modified with a functional group. Compared to an unmodified conjugated diene rubber, a terminal-modified conjugated diene rubber has an improved compatibility with filler, which is a reinforcing agent, such as carbon black and silica. Such terminal-modified conjugated diene rubber achieves reduced heat generation and thereby fuel economy performance can be improved.

### RELATED ART

### Patent Document

### Patent Document 1: JP-A-2003-171418

### DISCLOSURE OF INVENTION

### Problems to be Solved by the Invention

Meanwhile, in regards to such pneumatic tires, not only enhanced fuel economy performance but also expanded tire lifespan can contribute to the reduction of environmental loads. Therefore, a rubber material with high strength and excellent abrasion resistance has been demanded.

The present disclosure has been made in consideration of the above problems, and one object of the present disclosure is to provide a rubber material with high strength and excellent abrasion resistance for various applications such as pneumatic tires.

### Means for Solving the Problems

The present disclosure provides a hydrogenated conjugated diene polymer and a production method of the same, a polymer composition, a crosslinked polymer, and a tire described below in order to solve the above problems.

[1] A hydrogenated conjugated diene polymer comprising, a structural unit derived from a conjugated diene compound and a structural unit derived from an aromatic vinyl compound, wherein an amount of the structural unit derived from the aromatic vinyl compound is 30 mass % or more with respect to entire structural units derived from monomers of the polymer, and wherein when composition ratios of a structural unit represented by the following Formula (3), a structural unit represented by the following Formula (4), a structural unit represented by the following Formula (5), and a structural unit represented by the following Formula (6) are represented by p, q, r, and s, respectively, the following Expression (A) is satisfied.

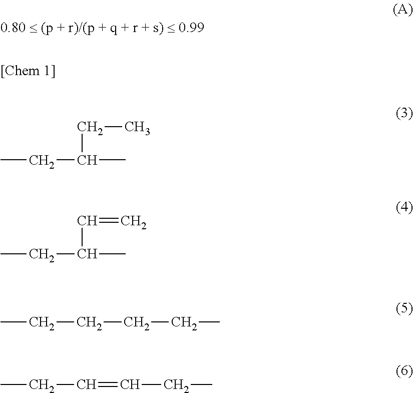

[2] A hydrogenated conjugated diene polymer comprising, a structural unit derived from a conjugated diene compound and a structural unit derived from an aromatic vinyl compound, wherein the conjugated diene compound includes butadiene, an amount of the structural unit derived from the aromatic vinyl compound is 30 mass % or more with respect to entire structural units derived from monomers of the polymer, and a hydrogenation rate of the structural unit derived from butadiene is 80% to 99%.

[3] A method of producing a hydrogenated conjugated diene polymer comprising a step of hydrogenating a conjugated diene polymer comprising a structural unit derived from a conjugated diene compound and a structural unit derived from an aromatic vinyl compound, wherein the conjugated diene compound includes butadiene, and an amount of the structural unit derived from the aromatic vinyl compound is 30 mass % or more with respect to entire structural units derived from monomers of the polymer, wherein the conjugated diene polymer is hydrogenated such that a hydrogenation rate of the structural unit derived from butadiene is to be 80% to 99%.

[4] A polymer composition comprising, the hydrogenated conjugated diene polymer according to [1] or [2] or a hydrogenated conjugated diene polymer obtained by the production method according to [3] and a crosslinking agent.

[5] A crosslinked polymer obtained by crosslinking the polymer composition according to [4].

[6] A tire in which the crosslinked polymer according to [5] is used as a material for at least a tread or a side wall.

### Effects of the Invention

Based on the present disclosure, a vulcanized rubber with high strength and excellent abrasion resistance can be obtained by using a specific hydrogenated conjugated diene polymer comprising a structural unit derived from butadiene and a structural unit derived from an aromatic vinyl compound.

### Embodiments for Carrying Out the Invention

Hereinafter, matters regarding an embodiment of the present disclosure are described in detail. In the present specification, the numeric ranges described using the preposition “to” include the numbers before and after “to” as the lower limit and the upper limit.

A hydrogenated conjugated diene polymer of the present disclosure is a hydrogenated product of a specific conjugated diene polymer comprising a structural unit derived from a conjugated diene compound and a structural unit derived from an aromatic vinyl compound. The hydrogenated conjugated diene polymer may be produced by polymerizing monomers containing a conjugated diene compound and an aromatic vinyl compound to obtain a conjugated diene polymer first and then hydrogenating the obtained conjugated diene polymer.

<Conjugated Diene Polymer>

The conjugated diene compound used in the polymerization contains at least 1,3-butadiene. In the polymerization, as the conjugated diene compound, 1,3-butadiene may be used singly or a conjugated diene compound other than 1,3-butadiene may be used in combination therewith (hereinafter, also referred to as “other conjugated diene compound”). Examples of the other conjugated diene compound include isoprene, 2,3-dimethyl-1,3-butadiene, 1,3-pentadiene, 1,3-hexadiene, 1,3-heptadiene, 2-phenyl-1,3-butadiene, 3-methyl-1,3-pentadiene, and 2-chloro-1,3-butadiene. Among these, isoprene and 2,3-dimethyl-1,3-butadiene are preferable. Further, the other conjugated diene compound may be used singly or two or more thereof may be used in combination.

From the viewpoint of improving the balance between low hysteresis loss characteristics and grip characteristics, and processability of the vulcanized rubber to be obtained by using the hydrogenated conjugated diene polymer of the present disclosure, the use rate of 1,3-butadiene in polymerization is preferably 40 mass % or more, more preferably 50 mass % or more. The upper limit of the use rate of the 1,3-butadiene is preferably 70 mass % or less, and more preferably 67 mass % or less with respect to the total amount of monomers to be used in the polymerization.

Examples of the aromatic vinyl compound include styrene, 2-methyl styrene, 3-methyl styrene, 4-methyl styrene, α-methylstyrene, 2,4-dimethylstyrene, 2,4-diisopropylstyrene, 4-t-butylstyrene, 5-t-butyl-2-methylstyrene, vinyl ethylbenzene, divinylbenzene, trivinylbenzene, divinylnaphthalene, t-butoxystyrene, vinylbenzyldimethylamine, (4-vinylbenzyl) dimethylaminoethyl ether, N,N-dimethylaminoethylstyrene, N,N-dimethylaminomethylstyrene, 2-ethylstyrene, 3-ethylstyrene, 4-ethylstyrene, 2-t-butylstyrene, 3-t-butylstyrene, 4-t-butylstyrene, vinylxylene, vinylnaphthalene, vinylpyridine, diphenylethylene, and diphenylethylene containing a tertiary amino group (for example, 1-(4-N,N-dimethylaminophenyl)-1-phenylethylene). Among these aromatic vinyl compound, styrene and α-methylstyrene are preferable. The aromatic vinyl compounds may be used singly or two or more thereof may be used in combination.

Among the conjugated diene polymers, which are copolymers of a conjugated diene compound and an aromatic vinyl compound, a copolymer using 1,3-butadiene and styrene is preferable from the viewpoint that the anionic polymerization is likely to occur in a form of living polymerization.

Regarding the copolymer of a conjugated diene compound and an aromatic vinyl compound, the content percentage of the structural unit derived from the aromatic vinyl compound included in the copolymer (that is, the hydrogenated conjugated diene polymer of the present disclosure) is 30 mass % or more with respect to the entire structural units derived from monomers in the polymer. If the content percentage of the structural unit derived from the aromatic vinyl compound in the hydrogenated conjugated diene polymer of the present disclosure is less than 30 mass %, the vulcanized rubber to be obtained may fail to exhibit effects such as material strength (breaking strength, elongation at break), abrasion resistance, and wet grip characteristics. The content percentage is more preferably 32 mass % or more, and even more preferably 33 mass % or more. Further, the upper limit of the content percentage of the structural unit derived from the aromatic vinyl compound in the conjugated diene polymer is preferably 50 mass % or less, more preferably 45 mass % or less, and even more preferably 40 mass % or less from the viewpoint of improving the balance between low hysteresis loss characteristics and grip characteristics and improving processability of the vulcanized rubber to be obtained. Therefore, in polymerization, the use rate of the aromatic vinyl compound is preferably chosen such that the content percentage of the structural unit derived from the aromatic vinyl compound in the conjugated diene polymer to be obtained is to be within the above range. The content percentage of the structural unit derived from the aromatic vinyl compound in the polymer is measured by ¹H-NMR.

In the polymerization, another monomer other than the conjugated diene compound and the aromatic vinyl compound may also be used. Examples of the other monomer include acrylonitrile, methyl (meth)acrylate, ethyl (meth)acrylate, and hydroxyethyl (meth)acrylate. The use rate of the other monomer is preferably less than 25 mass %, more preferably 15 mass % or less, and even more preferably 10 mass % or less, with respect to the total amount of the monomers to be used in the polymerization.

Any of solution polymerization method, gas phase polymerization method, and bulk polymerization method may be used as the polymerization method. Solution polymerization method is particularly preferable. The polymerization style may be either batch system or continuous system. Specifically, in the case of employing solution polymerization method, examples of polymerization method include a method in which monomers containing a conjugated diene compound and an aromatic vinyl compound is polymerized in an organic solvent under the presence of a polymerization initiator and a randomizer which is used as necessary.

The polymerization initiator to be used may be an alkali metal compound or an alkali earth metal compound. Specific examples of these include: alkyllithiums such as methyllithium, ethyllithium, n-propyllithium, n-butyllithium, sec-butyllithium, and t-butyllithium; 1,4-dilithiobutane, phenyllithium, stilbenclithium, naphthyllithium, 1,3-bis(1-lithio-1,3-dimethylpentyl)benzene, 1,3-phenylenebis(3-methyl-1-phenylpentylidene)dilithium, naphthyl sodium, naphthyl potassium, di-n-butylmagnesium, di-n-hexyl magnesium, ethoxy potassium, and calcium stearate. Among these, lithium compounds are preferable.

Further, the polymerization reaction may be performed under the presence of a compound obtained by mixing an alkali metal compound or an alkali earth metal compound with a compound having a functional group that interacts with silica (hereinafter, also referred to as “modification initiator”). Polymerization under the presence of modification initiator enables introduction of the functional group that interacts with silica into the polymerization initiating terminal of the conjugated diene polymer.

Further, in the present specification, “interaction” means forming a covalent bond between molecules or forming intermolecular forces weaker than covalent bond (e.g., electromagnetic forces acting between molecules such as ion-dipole interaction, dipole-dipole interaction, hydrogen bonding, and van der Waals force). “Functional group interacting with silica” is preferably a group having at least one atom selected from the group consisting of a nitrogen atom, a sulfur atom, a phosphorus atom, and an oxygen atom.

Among the modification initiators, a reaction product of a lithium compound such as alkyllithium and a nitrogen-containing compound such as a secondary amine compound are preferable. Specific examples of the nitrogen-containing compound include dimethylamine, diethylamine, dipropylamine, dibutylamine, dodecamethyleneimine, N,N′-dimethyl-N′-trimethylsilyl-1,6-diaminohexane, piperidine, pyrrolidine, hexamethyleneimine, heptamethyleneimine, dicyclohexylamine, N-methylbenzylamine, di-(2-ethylhexyl)amine, diallylamine, morpholine, N-(trimethylsilyl) piperazine, N-(tert-butyldimethylsilyl) piperazine, and 1,3-ditrimethylsilyl-1,3,5-triazinane. In the case where the polymerization is performed under the presence of the modification initiator, the polymerization may be performed by mixing an alkali metal compound or an alkali earth metal compound with a compound having a functional group that interacts with silica to prepare the modification initiator, and then adding the prepared modification initiator in the polymerization system. Alternatively, the polymerization may be performed by adding an alkali metal compound or an alkali earth metal compound and a compound having a functional group that interacts with silica in the polymerization system, and then mixing both of them to prepare the modification initiator in the polymerization system.

A randomizer may be used for the purpose of adjusting the vinyl bond content that represents the content rate of the vinyl bond (1,2-bonding and 3,4-bonding) in the polymer. Examples of the randomizers include dimethoxybenzene, tetrahydrofuran, dimethoxyethane, diethylene glycol dibutyl ether, diethylene glycol dimethyl ether, 2,2-di(tetrahydrofuryl)propane, 2-(2-ethoxyethoxy)-2-methylpropane, triethylamine, pyridine, N-methylmorpholine, and tetramethylethylenediamine. These may be used singly or two or more thereof may be used in combination.

The organic solvent to be used in the polymerization may be any organic solvent inert to the reaction; as examples thereof, aliphatic hydrocarbons, alicyclic hydrocarbons, and aromatic hydrocarbons can be exemplified. Among these, hydrocarbons having 3 to 8 carbon atoms are preferable. Specific example thereof include propane, n-butane, isobutene, n-pentane, isopentane, n-hexane, cyclohexane, propene, 1-butene, isobutene, trans-2-butene, cis-2-butene, 1-pentyne, 2-pentyne, 1-hexene, 2-hexene, benzene, toluene, xylene, ethylbenzene, heptane, cyclopentane, methylcyclopentane, methylcyclohexane, 1-pentene, 2-pentene, and cyclohexene. The organic solvents may be used singly, or two or more thereof may be used in combination.

In the case where a solution polymerization is used, the monomer concentration in the reaction solvent is preferably 5 to 50 mass %, and more preferably 10 to 30 mass %, from the viewpoint of maintaining the balance between productivity and ease of control on polymerization. The temperature for the polymerization reaction is preferably −20° C. to 150° C., more preferably 0° C. to 120° C., and particularly preferably 20° C. to 100° C. The polymerization reaction is preferably performed under sufficiently enough pressure for substantially maintaining the monomers in liquid phase. Such a pressure can be provided with a method of pressurizing the inside of a reactor with a gas inert to the polymerization reaction or the like.

Through such polymerization reaction, a conjugated diene polymer having an active terminal may be obtained. The preferable weight-average molecular weight (Mw) of the conjugated diene polymer to be obtained is 1.0×10⁴ to 2.0×10⁶ in terms of polystyrene, which is determined by gel permeation chromatography (GPC). In the case where Mw is less than 1.0×10⁴, fuel economy performance and abrasion resistance of the crosslinked body of the hydrogenated conjugated diene polymer tend to decrease, and in the case where Mw is more than 2.0×10⁶, processability of the polymer composition tends to decrease. The Mw range is more preferably 3.0×10⁴ to 1.5×10⁶, and even more preferably 5.0×10⁴ to 1.0×10⁶.

In the conjugated diene polymer to be subjected to the hydrogenation reaction, the vinyl bond content in the structural unit derived from butadiene is preferably 5 to 70 mol %, more preferably 10 to 60 mol %, and even more preferably 25 to 60 mol %. In obtaining the hydrogenated conjugated diene polymer of the present disclosure, in the case where the vinyl bond content in the conjugated diene polymer is less than 5 mol %, processability of the polymer composition to be obtained tends to decrease, and in a case where the vinyl bond content is more than 70 mol %, abrasion resistance of the polymer composition to be obtained tends to decrease. Further, in the present specification, “vinyl bond content” indicates a value of the content percentage of the structural unit having 1,2-bonding in the conjugated diene polymer before hydrogenation with respect to the entire structural units derived from butadiene, which is measured by ¹H-NMR.

The conjugated diene polymer obtained through such polymerization is a copolymer of a conjugated diene compound and an aromatic vinyl compound, and includes a randomly copolymerized moiety in which the conjugated diene compound and the aromatic vinyl compound are disorderly distributed. Such a copolymer may include a block consisting of the structural units derived from a conjugated diene compound at one or both of the terminals of the copolymer.

There is no particular limitation on the conjugated diene compound constituting the block. The copolymer may include, for example, a block consisting of a structural unit derived from a conjugated diene compound different from 1,3-butadiene. Specific examples thereof include a block consisting of a structural unit derived from isoprene (hereinafter, also referred to as “polyisoprene block”). In the case where the conjugated diene polymer obtained through such polymerization process includes a polyisoprene block at one or both of the terminals, a polymer with high hydrogenation rate can be effectively vulcanized. The ratio of 1,4-bonding to 3,4-bonding in the polyisoprene block is preferably within a range of 60/40 to 98/2. Adjustment of the ratio of 1,4-bonding to 3,4-bonding into the range allows both to obtain flexible vulcanized rubber and to achieve high crosslinking efficiency.

Regarding the conjugated diene polymer, the percentage of the conjugated diene compound constituting the block is preferably 1 to 25 mass % with respect to the entire amount of the monomers to be used in polymerization from the viewpoint of efficiently achieving vulcanization while sufficiently improving the mechanical strength and abrasion resistance of the crosslinked polymer obtained by using the hydrogenated conjugated diene polymer of the present disclosure. The percentage is more preferably 1 to 20 mass %, and even more preferably 3 to 15 mass %.

There is no particular limitation on the method for obtaining the conjugated diene polymer including a randomly copolymerized moiety and a block moiety. Examples thereof include: a method of polymerizing a conjugated diene compound to obtain a block polymer including active terminals, and then polymerizing the block polymer after adding a conjugated diene compound and an aromatic vinyl compound into the reaction system; and a method of polymerizing a conjugated diene compound and an aromatic vinyl compound to obtain a random copolymer having an active terminal, and then polymerizing the random copolymer after adding a conjugated diene compound into the reaction system.

### <Reaction Between Polymerization Active Terminal and Compound>

Polymerization of the conjugated diene polymer obtained through the aforesaid polymerization process may be stopped using an alcohol or the like. The conjugated diene polymer having an active terminal may be further subjected to a reaction with a compound having a functional group that interacts with silica (hereinafter, also referred as “modification compound”) or with a coupling agent.

In the case where the reaction includes a step of reacting the conjugated diene polymer obtained through the aforesaid polymerization process with a modification compound, a polymer having a terminal modified with a functional group that interacts with silica can be obtained as a hydrogenated conjugated diene compound of the present disclosure. By using the conjugated diene polymer obtained through polymerization using a modification initiator as the conjugated diene copolymer to be subjected to the reaction with the modification compound, a polymer having a functional group that interacts with silica at both terminals can be obtained.

There is no particular limitation on the modification compound as long as the compound has a functional group that interacts with silica and the compound is capable of reacting with an active terminal of a polymer. Preferable specific examples of the modification compound include the followings (I) to (III):

(I) Compound (B2-1) represented by the following Formula (1);

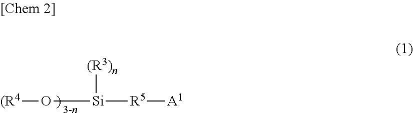

(In Formula (1), A¹ includes at least one atom selected from the group consisting of a nitrogen atom, a phosphorus atom, and a sulfur atom, does not have active hydrogen, and is a monovalent functional group that is bonded to R⁵ through a nitrogen atom, a phosphorus atom, or a sulfur atom. R³ and R⁴ are hydrocarbyl groups, R⁵ is a hydrocarbylene group, and n is an integer of 0 to 2. In the case where there are a plurality of R³'s and R⁴'s, the plurality of R³'s and R⁴'s may be the same as or different from each other.)

(II) Compound (B2-2) having one or more of each of a functional group X, which is at least one selected from the group consisting of a cyclic ether group, a (thio)carbonyl group, and an iso(thio)cyanate group, and a group Y having at least one atom selected from the group consisting of a nitrogen atom, a phosphorus atom, an oxygen atom, and a sulfur atom (here, at least any one of the nitrogen atom, the phosphorus atom, and the sulfur atom may be protected with a trisubstituted hydrocarbylsilyl group) and not having active hydrogen, which is different from the functional group X; and

(III) Compound (B2-3) having two or more iso(thio) cyanate groups in the molecule.

The modification compounds may be used singly, or two or more thereof may be used in combination. In the present specification, (thio)carbonyl group means a carbonyl group and a thiocarbonyl group, and iso(thio)cyanate group means an isocyanate group and an isothiocyanate group.

In Formula (1), the hydrocarbyl group as R³ and R⁴ are preferably linear or branched alkyl groups having 1 to 20 carbon atoms, cycloalkyl groups having 3 to 20 carbon atoms, or aryl groups having 6 to 20 carbon atoms.

R⁵ is preferably a linear or branched alkanediyl group having 1 to 20 carbon atoms, a cycloalkylene group having 3 to 20 carbon atoms, or an arylene group having 6 to 20 carbon atoms.

n is preferably 0 or 1 from the viewpoint of increasing the reactivity with the conjugated diene polymer.

A¹ has at least one atom selected from the group consisting of a nitrogen, a phosphorus atom, and a sulfur atom (hereinafter, also referred to as “specific atom”), and is bonded to R⁵ through these specific atoms. The specific atom is not bonded to active hydrogen, and may be protected with a protective group.

In the present specification, the term “active hydrogen” refers to a hydrogen atom that is bonded to an atom other than carbon atom, preferably a hydrogen atom having a binding energy lower than that of the carbon-hydrogen bond of polymethylene. The term “protective group” refers to a functional group that converts and keeps A¹ as a functional group inert to the polymerization active terminal, and examples thereof include a trisubstituted hydrocarbylsilyl group.

Among the groups, A¹ is preferably a group capable of forming an onium ion by an onium salt forming agent. Presence of such a group (A′) in the modification compound allows the hydrogenated conjugated diene polymer to be obtained to exhibit excellent shape retention ability.

Specific examples of A¹ include a nitrogen-containing group with substitution of two hydrogen atoms in a primary amino group with two protective groups, a nitrogen-containing group with substitution of one hydrogen atom in a secondary amino group with one protective group, a tertiary amino group, a group having a carbon-nitrogen double bond, a nitrogen-containing heterocyclic group, a phosphorus-containing group with substitution of two hydrogen atoms in a primary phosphino group with two protective groups, a phosphorus-containing group with substitution of one hydrogen atom in a secondary phosphino group with one protective group, a tertiary phosphino group, and a sulfur-containing group with substitution of one hydrogen atom of thiol group with one protective group. Among these, a group having a nitrogen atom is preferable from the viewpoint of the high affinity to silica. There is no particular limitation on the protective groups; examples thereof include a trisubstituted hydrocarbylsilyl group.

Specific examples of Compound (B2-1) include a compound having a nitrogen-containing group with substitution of two hydrogen atoms in a primary amino group with two protective groups, a nitrogen-containing group with substitution of one hydrogen atoms in a secondary amino group with one protective group, a tertiary amino group, and an alkoxysilyl group, which may be exemplified as follows: N,N-bis(trimethylsilyl)aminopropyltrimethoxysilane, N,N-bis(trimethylsilyl)aminopropylmethyldiethoxysilane, N,N′,N′-tris(trimethylsilyl)-N-(2-aminoethyl)-3-aminopropyltriethoxysilane, 3-(4-trimethylsilyl-1-piperazino)propylmethyldimethoxysilane, and compounds in which the alkyl group and the alkanediyl group in these compounds have been substituted with an alkyl group having 1 to 6 carbon atoms and an alkanediyl group having 1 to 6 carbon atom, respectively.

Examples of a compound having a group having a carbon-nitrogen double bond or a nitrogen-containing heterocyclic group, and an alkoxysilyl group include N-(1,3-dimethylbutylidene)-3-(triethoxysilyl)-1-propanamine, N-(1-methylpropylidene)-3-(triethoxysilyl)-1-propanamine, N-(4-N,N-dimethylaminobenzylidene)-3-(triethoxysilyl)-1-propanamine, N-(cyclohexylidene)-3-(triethoxysilyl)-1-propanamine, N-(3-trimethoxysilylpropyl)-4,5-dihydroimidazole, N-(3-trimethoxysilylpropyl)imidazole, 3-hexamethyleneiminopropyltrimethoxysilane, 3-hexamethyleneiminopropylmethyldimethoxysilane, 3-(1-piperidino)propyltrimethoxysilane, 3-(1-hexamethyleneimino)propyltrimethoxysilane, 3-(1-piperazinyl)propyltrimethoxysilane, 3-morpholinopropyltrimethoxysilane, and compounds in which the alkyl group and the alkanediyl group in these compounds have been substituted with an alkyl group having 1 to 6 carbon atoms and an alkanediyl group having 1 to 6 carbon atoms, respectively.

Examples of a compound having a phosphorus-containing group with substitution of two hydrogen atoms in a primary phosphino group with two protective groups, a phosphorus-containing group with substitution of one hydrogen atom in a secondary phosphino group with one protective group, a tertiary phosphino group, or a sulfur-containing group with substitution of one hydrogen atom in a thiol group with one protective group, and an alkoxysilyl group include: P,P-bis(trimethylsilyl)phosphinopropylmethyldimethoxysilane, P,P-bis(trimethylsilyl)phosphinopropyltrimethoxysilane, 3-dimethylphosphinopropyltrimethoxysilane, 3-dimethylphosphinopropylmethyldimethoxysilane, 3-diphenylphosphinopropyltrimethoxysilane, 3-diphenylphosphinopropylmethyldimethoxysilane, S-trimethylsilylmercaptopropylmethyldimethoxysilane, S-trimethylsilylmercaptopropyltrimethoxysilane, and compounds in which the alkyl group and the alkanediyl group in these compounds have been substituted with an alkyl group having 1 to 6 carbon atoms and an alkanediyl group having 1 to 6 carbon atoms, respectively. Examples of a compound having an iso(thio)cyanate group include 3-isocyanatopropyltrimethoxysilane and 3-isocyanatopropyltriethoxysilane. Compound (B2-1) may be used singly, or two or more thereof may be used in combination.

In Compound (B2-2), the group Y is preferably a group containing a nitrogen atom that is not bonded to active hydrogen. Specific examples of Compound (B2-2) in this case include, as a compound having a cyclic ether group, an epoxyamine compound such as tetraglycidyl-1,3-bisaminomethylcyclohexane;

as a compound having a (thio)carbonyl group, 4-aminoacetophenone such as 4-N,N-dimethylaminobenzophenone; bis(dihydrocarbylaminoalkyl)ketone such as 1,7-bis(methylethyl amino)-4-heptanone; dihydrocarbylaminoalkyl(meth)acrylate such as 2-dimethylaminoethyl acrylate;

hydrocarbylimidazolidinone such as 1,3-dimethyl-2-imidazolidinone; N-hydrocarbylpyrrolidone such as 1-phenyl-2-pyrrolidone; N-hydrocarbylcaprolactam such as N-methyl-s-caprolactam; N-dihydrocarbylformamide such as N,N-diethylformamide; N,N-dihydrocarbylacetamide such as N,N-dimethylacetamide; (meth)acrylamide such as N,N-dimethylacrylamide; and the like; and as a compound having an iso(thio)cyanate group, 3-isocyanatopropyltrimethoxysilane, and the like. Compound (B2-2) may be used singly, or two or more thereof may be used in combination.

Examples of Compound (B2-3) include 2,4-tolylene diisocyanate, 2,6-tolylene diisocyanate, diphenylmethane diisocyanate, naphthalene diisocyanate, triphenylmethane triisocyanate, p-phenylenediisocyanate, tris(isocyanatophenyl)thiophosphate, xylene diisocyanate, benzene-1,2,4-triisocyanate, naphthalene-1,2,5,7-tetraisocyanate, and 1,4-phenylene diisothiocyanate. Compound (B2-3) may be used singly, or two or more thereof may be used in combination.

The modification compound to be used is particularly preferably Compound (B2-1) due to the strong affinity thereof to silica. Further, in the case where Compound (B2-1) is used, silicon tetrachloride, epoxy-containing compound (for example, tetraglycidyl-1,3-bisaminomethylcyclohexane), or the like may be used in combination with Compound (B2-1) for the purpose of adjusting the Mooney viscosity of the modified conjugated diene polymer.

Examples of the coupling agent to be subjected to the reaction with an active terminal of a polymer include succinic acid amide, phthalic acid amide, dibenzoyl pyridine, dibutyl dichlorosilicon, methyl trichlorosilicon, methyl dichlorosilicon, tetrachlorosilicon (silicon tetrachloride), silicon tetrabromide, silicon tetraiodide, trichloromethoxysilane, tribromomethoxy silane, trimethoxysilane, methyltriethoxysilane, tetramethoxysilane, tetraethoxysilane, dimethyl adipate, dimethyl terephthalate, tetrachloro tin, tetrabromo tin, trichlorobutyl tin, trichloromethyl tin, trichloroethyl tin, trichlorophenyl tin, trichloro octyl tin, butyl tin tris octanoate, dibutyl tin bislaurate, ethylene glycol diglycidyl ether, trichlorophosphine, pyromellitic anhydride, divinylbenzene, and trichloropropane. The coupling agent may be used singly, or two or more thereof may be used in combination.

The reaction of the polymerization active terminal with the modification compound or the coupling agent may be carried out in a form of solution reaction, for example. This solution reaction may be carried out with a solution including unreacted monomers after completion of polymerization reaction, or may be carried out after the conjugated diene polymer included in the solution is isolated and then dissolved into a proper solvent such as cyclohexane. The reaction may be carried out in either batch system or continuous system. In this case, there is no particular limitation on a method of adding the compound to be subjected to the reaction with the polymerization active terminal; examples thereof include a method in which the compound is added all at once, a method in which the compound is separately added, and a method in which the compound is continuously added.

The amount of the modification compound to be used in the above reaction may be appropriately adjusted depending on the kind of the compound to be used in the reaction. The amount is preferably 0.1 mol equivalent or more, and more preferably 0.3 mol equivalent or more with respect to the metal atom participating in the polymerization reaction included in the polymerization initiator. With 0.1 mol equivalent or more of the amount of the modification compounds, the modification reaction can be sufficiently proceeded and this allows silica to have enhanced dispersibility suitably. The amount to be used of the coupling agent is preferably 0.1 mol equivalent or more, and more preferably 0.3 mol equivalent or more with respect to the metal atom participating in the polymerization reaction included in the polymerization initiator.

The temperature of the above reaction is usually the same as the temperature of the polymerization reaction and is preferably set to the temperature at −20° C. to 150° C., more preferably 0° C. to 120° C., and particularly preferably 20° C. to 100° C. In the case where the reaction temperature is low, the viscosity of the conjugated diene polymer after modification tends to increase. Meanwhile, in the case where the reaction temperature is high, the activity of the polymerization active terminal tends to be lost. The reaction time is preferably 1 minute to 5 hours, and more preferably 2 minutes to 1 hour.

### <Hydrogenation Reaction>

The hydrogenated conjugated diene polymer of the present disclosure can be obtained by adding hydrogen (hydrogenation) to a conjugated diene polymer of which the content percentage of the structural unit derived from an aromatic vinyl compound is within a specific range. The conjugated diene polymer to be subjected to the hydrogenation reaction may be a copolymer in which the terminals thereof are unmodified, or a modified copolymer in which one or both of terminals have been modified. In the case of applying the conjugated diene polymer to tire applications, the modified copolymer in which one or both of the terminals thereof have been modified is preferably used from the viewpoint of enhancing various tire characteristics of the vulcanized rubber.

Regarding the method and the condition of the hydrogenation reaction, any method and condition can be employed as long as a polymer with a desired hydrogenation rate can be obtained. Examples of those hydrogenation methods include a method in which a catalyst having an organic metal compound of titanium as the main component is used as the hydrogenation catalyst, a method in which a catalyst is used which consists of organic compounds of iron, nickel, and cobalt, and an organic metal compound such as alkylaluminum, a method in which an organic complex of organic metal compounds of ruthenium, rhodium, and the like is used, and a method using a catalyst in which a metal such as palladium, platinum, ruthenium, cobalt, and nickel is supported on a carrier such as carbon, silica, and alumina. Among various methods, a method of hydrogenating under mild conditions of low pressure and low temperature with a homogeneous catalyst composed of titanium organometallic compound alone or an organometallic compound of lithium, magnesium, and aluminum (JP-B-63-4841, JP-B-1-37970) is industrially preferable. The high hydrogenation selectivity on the double bond derived from butadiene also makes it suitable for the purpose of the present disclosure.

Hydrogenation is performed in a solvent that is inert to the catalyst into which a conjugated diene polymer is soluble. Examples of preferable solvents include each of aliphatic hydrocarbons such as n-pentane, n-hexane, and n-octane, alicyclic hydrocarbons such as cyclohexane and cycloheptane, aromatic hydrocarbons such as benzene and toluene, and ethers such as diethyl ether and tetrahydrofuran, or a mixture including those as the main components.

Hydrogenation reaction is typically performed by keeping a polymer under hydrogen or inert atmosphere at a predetermined temperature, by adding a hydrogenation catalyst under either stirring or none-stirring, and by introducing hydrogen gas and pressurizing the gas to a predetermined pressure. The term “inert atmosphere” means atmosphere which does not react with participants of hydrogenation reaction, and the inert atmosphere may be formed of, for example, helium, neon, and argon. Air and oxygen may oxidize the catalyst and cause the catalyst to lose the activity thereof, and thus are not preferable. Nitrogen acts as catalyst poison in hydrogenation reaction and decreases hydrogenation activity, and thus is not preferable. In particular, an atmosphere of hydrogen gas alone is preferable in a hydrogenation reactor.

The hydrogenation reaction process through which the hydrogenated conjugated diene polymer is obtained may employ any of a batch process, a continuous process, and combination thereof. When a titanocene diaryl compound is used as the hydrogenation catalyst, this compound may be added alone as it is into the reaction solution, or may be added in a form of a solution of an inert organic solvent. In the case of adding the catalyst in a form of solution, there is no particular limitation on the inert organic solvent to be used as long as the solvent does not have reactivity with the participants of hydrogenation reaction. The inert organic solvent is preferably the same solvent as the solvent used in hydrogenation reaction. The amount to be added of the hydrogenation catalyst is preferably set to 0.02 to 20 millimole per 100 g of conjugated diene polymer before hydrogenation.

In regards to the hydrogenation rate of the hydrogenated conjugated diene polymer of the present disclosure, the hydrogenation rate of the structural unit derived from butadiene is in a range of 80% to 99%. By hydrogenating a conjugated diene polymer in which the content percentage of the structural unit derived from an aromatic vinyl compound is within a specific range to cause the polymer to have 80% or more of hydrogenation rate, a hydrogenated copolymer required for obtaining vulcanized rubber with high strength and excellent abrasion resistance can be obtained. The hydrogenation rate of the hydrogenated copolymer is preferably 85% or more, and more preferably 91% or more from the viewpoint of sufficiently achieving the effects of the present disclosure. From the viewpoint of ensuring the hydrogenated conjugated polymer to have enough double bonds for vulcanization, the upper limit of the hydrogenation rate is 99% or less, preferably 98% or less, and more preferably 97% or less. The hydrogenation rate is measured by ¹H-NMR. The hydrogenation rate can be freely chosen by changing the amount of the hydrogenation catalyst, the hydrogen pressure and the reaction time of hydrogenation reaction.

The preferable method to obtain the hydrogenated conjugated diene polymer is a method of solution-polymerizing a conjugated diene compound and an aromatic vinyl compound under the presence of an organic lithium catalyst and then using the obtained polymer solution for the next hydrogenation reaction as it is. Such method is industrially useful. The hydrogenated conjugated diene polymer of the present disclosure is obtained by removing the solvent from the obtained solution described above and then isolating the polymer. Isolation of the polymer may be performed, for example, by known desolvation method such as steam stripping and drying operation such as heat treatment.

The hydrogenated conjugated diene polymer of the present disclosure obtained as such is a hydrogenated conjugated diene polymer having a structural unit derived from a conjugated diene compound and a structural unit derived from an aromatic vinyl compound, and satisfies the following requirements (a) and (b).

(a) The structural unit derived from the aromatic vinyl compound is 30 mass % or more with respect to entire structural units derived from monomers of the polymer.

(b) When composition ratios of a structural unit represented by Formula (3), a structural unit represented by Formula (4), a structural unit represented by Formula (5), and a structural unit represented by Formula (6) are represented by p, q, r, and s, respectively, the following Expression (A) is satisfied.

0.80≤(p+r)/(p+q+r+s)≤0.99 (A)

Expression (A) indicates that the hydrogenation rate of the structural unit derived from butadiene is 80% to 99%.

The hydrogenated conjugated diene polymer of the present disclosure preferably has one or more functional groups selected from the group consisting of an amino group (including a primary amino group, a secondary amino group, and a tertiary amino group), a group having a carbon-nitrogen double bond, a nitrogen-containing heterocyclic group, a phosphino group, a thiol group, and a hydrocarbyloxysilyl group at the polymer terminals. Including such a functional group in the polymer allows effective enhancement of dispersibility of reinforcing filling agent such as silica and improvement of low hysteresis loss characteristics, in a case where, for example, the polymer is applied to a tire. The amino group, the phosphino group, and the thiol group at the polymer terminal may be protected by, for example, a trisubstituted hydrocarbylsilyl group or the like.

Examples of preferable structures which the hydrogenated conjugated diene polymer may have at the terminal include a structure represented by the following Formula (2).

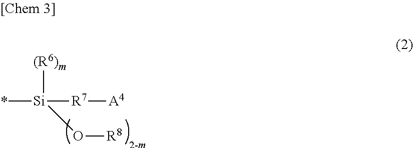

(In Formula (2), A⁴ represents a functional group having one or more atoms selected from the group consisting of N, P, and S, which are the atoms bonded to R⁷. R⁶ is a hydrocarbyl group, and m is 0 to 2. R⁷ is a hydrocarbylene group. R⁸ is a hydrogen atom or a hydrocarbyl group. In the formula, the plurality of R⁶'s and R⁸'s may be same or different. “*” represents a bond.)

In Formula (2), the description regarding R³ and R⁴ in Formula (1) may be applied to that of the hydrocarbyl group as R⁶ and R⁸, and the description regarding R⁵ in Formula (1) may be applied to R⁷. A part of or the entire N, P, and S included in A⁴ may be protected with a hydrocarbylsilyl group or the like. A⁴ is preferably an amino group, a group having a carbon-nitrogen double bond, a nitrogen-containing heterocyclic group, a phosphino group or a thiol group. The amino group, the phosphino group, and the thiol group referred to here may be protected with a trisubstituted hydrocarbylsilyl group or the like.

Examples of the group having a carbon-nitrogen double bond of A⁴ include “—N═CR¹¹R¹²” (here, R¹¹ is a hydrogen atom or a hydrocarbyl group, R¹² is a hydrocarbyl group). The description regarding R³ and R⁴ in Formula (1) may be applied to that of the hydrocarbyl group as R¹¹ and R¹². The nitrogen-containing heterocyclic group is a nitrogen-containing heterocycle from which one of the hydrogen atoms included therein is removed; examples thereof include 1-imidazolyl group, 4,5-dihydro-1-imidazolyl group, a 1-piperidino group, a 1-piperazinyl group, a pyridyl group, and a morpholino group.

The hydrogenated conjugated diene polymer of the present disclosure is obtained by hydrogenating a conjugated diene polymer having a content percentage of the structural unit derived from an aromatic vinyl compound within the above range such that the hydrogenation rate of the hydrogenated conjugated diene polymer is to be within a specific range. By using such a hydrogenated copolymer, a crosslinked polymer having excellent mechanical strength and abrasion resistance through crosslinking (vulcanization) can be obtained.

### <Polymer Composition>

A polymer composition of the present disclosure includes the hydrogenated conjugated diene polymer and the crosslinking agent. The content percentage of the hydrogenated conjugated diene polymer in the polymer composition is preferably 20 mass % or more, more preferably 30 mass % or more, and even more preferably 40 mass % or more with respect to the entire amount of the polymer composition. Examples of the crosslinking agent include sulfur, sulfur halides, organic peroxides, quinone dioximes, organic polyvalent amine compounds, alkylphenol resins having a methylol group; and usually used one is sulfur. The blending amount of sulfur is preferably 0.1 to 5 parts by mass, and more preferably 0.5 to 3 parts by mass with respect to 100 parts by mass of the total amount of the polymer component included in the polymer composition.

The polymer composition of the present disclosure may be blended with another rubber component in addition to the hydrogenated conjugated diene polymer. There is no particular limitation on types of such a rubber component, but it is preferable to use butadiene rubber (BR, for example, high cis BR having a 90% or more of cis-1,4 bond, and BR containing syndiotactic 1,2-polybutadiene (SPS)), styrene butadiene rubber (SBR), natural rubber (NR), isoprene rubber (IR), styrene isoprene copolymer rubber, butadiene isoprene copolymer rubber, and the like; and more preferred ones are BR and SBR.

Various reinforcing filling agent, such as carbon black, silica, clay, and calcium carbonate, may be blended in the polymer composition as filler. Carbon black, silica, or combination of carbon black and silica is preferably used. The total amount of silica and carbon black in the polymer composition is preferably 20 to 130 parts by mass, and more preferably 25 to 110 parts by mass with respect to 100 parts by mass of the entire amount of the polymer component included in the polymer composition.

Commonly used various additives for rubber composition for tires, such as an antioxidant, zinc white, a stearic acid, a softening agent, sulfur, a vulcanization accelerator, a silane coupling agent, a compatibilizer, a vulcanization aid, a processing aid, a process oil, and a scorch inhibitor, may be blended in the polymer composition in addition to the components described above. The blending ratio of these may be appropriately chosen depending on the types of the components insofar as not compromising the effect of the present disclosure.

The polymer composition of the present disclosure is applicable to various rubber products as crosslinked copolymer by being kneaded with the component blended as necessary, in addition to the polymer component and the crosslinking agent, by using a kneader such as an open type kneader (e.g., a roll), an internal type kneader (e.g., a Banbury mixer), and then by being crosslinked (vulcanized) after molding. Specifically, the polymer composition of the present disclosure is applicable for: tire applications such as tire treads, under treads, carcasses, side walls, and bead parts; sealing materials such as packings, gaskets, weather strips and O-rings; interior and exterior skin materials for various vehicles such as automobiles, ships, airplanes, and railroads; building materials; vibration damping rubbers for industrial machines and equipment; various hoses and hose covers such as diaphragms, rolls, radiator hoses, and air hoses; belts such as power transmission belts; lining; dust boots; materials for medical instruments; fender insulation materials; materials for electric wires; and other industrial products. In particular, the vulcanized rubber obtained by using the hydrogenated conjugated diene polymer of the present disclosure has high strength and excellent abrasion resistance, and thus can be suitably used as a material for a tread and a side wall of a tire.

Production of a tire may be carried out according to common methods. For example, in the case where the hydrogenated conjugated diene polymer is applied as a material for a side wall, the above-mentioned polymer composition is mixed in a kneader to form a sheet. The sheet is arranged outside the carcass, and then subjected to vulcanization molding so as to form a side wall rubber in accordance with a common method, thereby obtaining a pneumatic tire.

### EXAMPLES

Hereinafter, detailed description regarding the present invention will be provided based on Examples, but the present disclosure is not limited to the Examples. Further, the units “parts” and “%” in Examples and Comparative Examples are in terms of mass unless specified otherwise. Methods for measuring various material properties are shown below.

[Bound styrene content (%)]: Measured by ¹H-NMR at 500 MHz.
[Vinyl bond content (mol %)]: 1,2-vinyl bond content in polymer was measured by ¹H-NMR at 500 MHz.
[Molecular weight before modification]: Determined in terms of polystyrene from the retention time corresponding to the maximum peak point of the GPC curve obtained through gel permeation chromatography (GPC) (HLC-8120 GPC (trade name (manufactured by Tosoh Corporation))).

### (Condition for GPC)

Column: trade name “GMHXL” (manufactured by Tosoh Corporation), 2 columns

Column temperature: 40° C.

Mobile phase: tetrahydrofuran

Flow rate: 1.0 ml/minute

Sample concentration: 10 mg/20 ml

[Hydrogenation rate (%)]: Measured by ¹H-NMR at 500 MHz.

### Hydrogenated Conjugated Diene Polymer, Polymer Composition, and Crosslinked Polymer

### Example 1

### (1) Production and Evaluation of Hydrogenated Conjugated Diene Polymer A

Into a nitrogen-purged autoclave reactor having an internal volume of 50 L, 25600 g of cyclohexane, 179 g of tetrahydrofuran, 960 g of styrene, and 2176 g of 1,3-butadiene were charged. After the temperature of the contents in the reactor was adjusted to 45° C., polymerization was initiated by adding a cyclohexane solution including n-butyl lithium (69.94 mmol). Polymerization was performed under adiabatic condition, and the maximum temperature reached was 85° C.

At the point in which the polymerization conversion rate reached 99%, 64 g of butadiene was added, followed by further polymerization for 1 minute, and then 2.24 g of silicon tetrachloride was added, followed by reaction for 15 minutes.

Subsequently, the reaction solution was heated to 80° C. or higher to introduce hydrogen into the system. Then 2.18 g of [bis(η5-cyclopentadienyl)titanium(furfuryloxy)chloride] (also referred to as [chlorobis(2,4-cyclopentadienyl)titanium(IV)furfurylalkoxide]), 0.97 g of diethylaluminum chloride and 0.96 g of n-butyllithium were added and the reaction solution was reacted while keeping the hydrogen pressure 0.7 MPa or more. After reaching a predetermined hydrogen cumulative flow rate, the reaction solution was returned to normal temperature and normal pressure, and the reaction solution was withdrawn from the reaction vessel to obtain a polymer solution.

Subsequently, the polymer solution was desolvated by steam stripping (steam temperature: 190° C.) for 2 hours at a liquid phase temperature of 95° C. in a desolvation tank, and dried with a hot roll adjusted to 110° C. to obtain hydrogenated conjugated diene polymer A. The polymerization formulation of the obtained hydrogenated conjugated diene polymer A is shown in the following Table 1, and various material properties and the like are shown in the following Table 2.

### (2) Production and Evaluation of Crosslinked Polymer

With the hydrogenated conjugated diene polymer A obtained above, each component was blended according to the blending formulation shown in the following Table 3, and kneaded, thereby a polymer composition was produced. The kneading was carried out by the following method. Firstly, as a first stage of the kneading, a hydrogenated conjugated diene polymer, silica, a silane coupling agent, stearic acid, an antioxidant and zinc oxide were blended and kneaded under conditions of a filling rate of 72% and a revolution speed of 60 rpm using a plastomill (content: 250 ml) fitted with a temperature controlling device. Next, as a second stage of the kneading, the formulation obtained above was cooled to room temperature, and then sulfur and a vulcanization accelerator were blended thereto and kneaded. The product was molded and vulcanized with a vulcanizing press at 160° C. for a predetermined time to obtain a crosslinked polymer. Further, the following material properties were evaluated for the obtained crosslinked polymer. The measurement results are shown in the following Table 2.

### (Tensile Test)

Using the obtained crosslinked polymer, a tensile test was conducted in accordance with JIS K6251. Here, the stress at break (TB) and the elongation at break (EB) were measured at room temperature using Dumbbell Type 3 as a test sample. Higher numerical values of TB and EB indicate higher and better breaking strength and mechanical strength of the material.

### (Abrasion Resistance)

The crosslinked polymer was used as a measurement sample and was measured at 25° C. under a load of 10 N in accordance with JIS K6264-2:2005 using a DIN abrasion tester (manufactured by Toyo Seiki Co., Ltd.). The measurement result is indicated by an index assuming Comparative Example 1 as 100, and higher numerical value thereof indicates better abrasion resistance.

### (Wet Grip Performance)

Vulcanized rubber was used as a measurement sample, and tan δ at 0° C. was measured with a dynamic spectrometer (manufactured by Rheometrics, USA).

Measurements were made with tension dynamic strain of 0.14%, angular velocity of 100 radians per second. The measurement result is indicated by an index assuming Comparative Example 1 as 100, and higher numerical value thereof indicates better wet grip performance.

### Example 2

### (1) Production and Evaluation of Hydrogenated Conjugated Diene Polymer B

Into a nitrogen-purged autoclave reactor having an internal volume of 50 L, 25600 g of cyclohexane, 179 g of tetrahydrofuran, 1056 g of styrene, and 2080 g of 1,3-butadiene were charged. After the temperature of the contents in the reactor was adjusted to 45° C., polymerization was initiated by adding a cyclohexane solution including n-butyl lithium (67.94 mmol). Polymerization was performed under adiabatic condition, and the maximum temperature reached 85° C.

At the point in which the polymerization conversion rate reached 99%, 64 g of butadiene was added, followed by further polymerization for 1 minute, and then 2.18 g of silicon tetrachloride was added, followed by reaction for 15 minutes.

Subsequently, hydrogenation reaction and desolvation were carried out by the same operation as in Example 1, and drying was carried out with a hot roll adjusted to 110° C. to obtain hydrogenated conjugated diene polymer B. The polymerization formulation of the obtained hydrogenated conjugated diene polymer B is shown in the following Table 1, and various material properties and the like are shown in the following Table 2.

### (2) Production and Evaluation of Crosslinked Polymer

A polymer composition and a crosslinked polymer were produced in the same manner as in Example 1 except that the hydrogenated conjugated diene polymer A was replaced with the hydrogenated conjugated diene polymer B. Further, material properties were evaluated in the same manner as in Example 1 for the obtained crosslinked polymer. The measurement results are shown in the following Table 2.

### Example 3

### (1) Production and Evaluation of Hydrogenated Conjugated Diene Polymer C

Into a nitrogen-purged autoclave reactor having an internal volume of 50 L, 25600 g of cyclohexane, 179 g of tetrahydrofuran, 1088 g of styrene, and 2048 g of 1,3-butadiene were charged. After the temperature of the contents in the reactor was adjusted to 45° C., polymerization was initiated by adding a cyclohexane solution including n-butyl lithium (67.94 mmol). Polymerization was performed under adiabatic condition, and the maximum temperature reached 85° C.

At the point in which the polymerization conversion rate reached 99%, 64 g of butadiene was added, followed by further polymerization for 1 minute, and then 2.18 g of silicon tetrachloride was added, followed by reaction for 15 minutes.

Subsequently, hydrogenation reaction and desolvation were carried out by the same operation as in Example 1, and drying was carried out with a hot roll adjusted to 110° C. to obtain hydrogenated conjugated diene polymer C. The polymerization formulation of the obtained hydrogenated conjugated diene polymer C is shown in the following Table 1, and various material properties and the like are shown in the following Table 2.

### (2) Production and Evaluation of Crosslinked Polymer

A polymer composition and a crosslinked polymer were produced in the same manner as in Example 1 except that the hydrogenated conjugated diene polymer A was replaced with the hydrogenated conjugated diene polymer C. Further, material properties were evaluated in the same manner as in Example 1 for the obtained crosslinked polymer. The measurement results are shown in the following Table 2.

### Examples 4

### (1) Production and Evaluation of Hydrogenated Conjugated Diene Polymer D

Into a nitrogen-purged autoclave reactor having an internal volume of 50 L, 25600 g of cyclohexane, 179 g of tetrahydrofuran, 1280 g of styrene, and 1856 g of 1,3-butadiene were charged. After the temperature of the contents in the reactor was adjusted to 45° C., polymerization was initiated by adding a cyclohexane solution including n-butyl lithium (64.94 mmol). Polymerization was performed under adiabatic condition, and the maximum temperature reached was 85° C.

At the point in which the polymerization conversion rate reached 99%, 64 g of butadiene was added, followed by further polymerization for 1 minute, and then 2.11 g of silicon tetrachloride was added, followed by reaction for 15 minutes.

Subsequently, hydrogenation reaction and desolvation were carried out by the same operation as in Example 1, and drying was carried out with a hot roll adjusted to 110° C. to obtain hydrogenated conjugated diene polymer D. The polymerization formulation of the obtained hydrogenated conjugated diene polymer D is shown in the following Table 1, and various material properties and the like are shown in the following

Table 2.

### (2) Production and Evaluation of Crosslinked Polymer

A polymer composition and a crosslinked polymer were produced in the same manner as in Example 1 except that the hydrogenated conjugated diene polymer A was replaced with the hydrogenated conjugated diene polymer D. Further, material properties were evaluated in the same manner as in Example 1 for the obtained crosslinked polymer. The measurement results are shown in the following Table 2.

### Examples 5

### (1) Production and Evaluation of Hydrogenated Conjugated Diene Polymer E

Into a nitrogen-purged autoclave reactor having an internal volume of 50 L, 25600 g of cyclohexane, 179 g of tetrahydrofuran, 1088 g of styrene, and 2048 g of 1,3-butadiene were charged. After the temperature of the contents in the reactor was adjusted to 45° C., polymerization was initiated by adding a cyclohexane solution including n-butyl lithium (33.97 mmol). Polymerization was performed under adiabatic condition, and the maximum temperature reached 85° C.

At the point in which the polymerization conversion rate reached 99%, 64 g of butadiene was added, followed by further polymerization for 1 minute, and then a cyclohexane solution including 5.6 g of N,N-dimethylaminopropylmethyldiethoxysilane was added, followed by reaction for 15 minutes.

Subsequently, the reaction solution was heated to 80° C. or higher to introduce hydrogen into the system. Then 2.05 g of [bis(η5-cyclopentadienyl)titanium(furfuryloxy)chloride], 3.51 g of diethylaluminum chloride, and 0.86 g of n-butyllithium were added and the reaction solution was reacted while keeping the hydrogen pressure 0.7 MPa or more. After reaching a predetermined hydrogen cumulative flow rate, the reaction solution was returned to normal temperature and normal pressure, and the reaction solution was withdrawn from the reaction vessel to obtain a polymer solution.

Thereafter, hydrogenation reaction and desolvation were carried out by the same operation as in Example 1, and drying was carried out with a hot roll adjusted to 110° C. to obtain hydrogenated conjugated diene polymer E. The polymerization formulation of the obtained hydrogenated conjugated diene polymer E is shown in the following Table 1, and various material properties and the like are shown in the following Table 2.

### (2) Production and Evaluation of Crosslinked Polymer

A polymer composition and a crosslinked polymer were produced in the same manner as in Example 1 except that the hydrogenated conjugated diene polymer A was replaced with the hydrogenated conjugated diene polymer E. Further, material properties were evaluated in the same manner as in Example 1 for the obtained crosslinked polymer. The measurement results are shown in the following Table 2.

### Example 6

### (1) Production and Evaluation of Hydrogenated Conjugated Diene Polymer F

Into a nitrogen-purged autoclave reactor having an internal volume of 50 L, 25600 g of cyclohexane, 179 g of tetrahydrofuran, 1088 g of styrene, and 2048 g of 1,3-butadiene were charged. After the temperature of the contents in the reactor was adjusted to 45° C., polymerization was initiated by adding a cyclohexane solution including n-butyl lithium (33.97 mmol). Polymerization was performed under adiabatic condition, and the maximum temperature reached 85° C.

At the point in which the polymerization conversion rate reached 99%, 64 g of butadiene was added, followed by further polymerization for 1 minute, and then 8.5 g of N,N-bis(trimethylsilyl)aminopropylmethyldiethoxysilane was added, followed by reaction for 15 minutes.

Subsequently, the reaction solution was heated to 80° C. or higher to introduce hydrogen into the system. Then 2.05 g of [bis(η5-cyclopentadienyl)titanium(furfuryloxy)chloride], 3.51 g of diethylaluminum chloride, and 0.86 g of n-butyllithium were added and the reaction solution was reacted while keeping the hydrogen pressure 0.7 MPa or more. After reaching a predetermined hydrogen cumulative flow rate, the reaction solution was returned to normal temperature and normal pressure, and the reaction solution was withdrawn from the reaction vessel to obtain a polymer solution.

Thereafter, hydrogenation reaction and desolvation were carried out by the same operation as in Example 1, and drying was carried out with a hot roll adjusted to 110° C. to obtain hydrogenated conjugated diene polymer F. The polymerization formulation of the obtained hydrogenated conjugated diene polymer F is shown in the following Table 1, and various material properties and the like are shown in the following Table 2.

### (2) Production and Evaluation of Crosslinked Polymer

A polymer composition and a crosslinked polymer were produced in the same manner as in Example 1 except that the hydrogenated conjugated diene polymer A was replaced with the hydrogenated conjugated diene polymer F. Further, material properties were evaluated in the same manner as in Example 1 for the obtained crosslinked polymer. The measurement results are shown in the following Table 2.

### Example 7

### (1) Production and Evaluation of Hydrogenated Conjugated Diene Polymer G

Into a nitrogen-purged autoclave reactor having an internal volume of 50 L, 25600 g of cyclohexane, 179 g of tetrahydrofuran, 1088 g of styrene, and 2048 g of 1,3-butadiene were charged. After the temperature of the contents in the reactor was adjusted to 45° C., polymerization was initiated by adding a cyclohexane solution including n-butyl lithium (33.97 mmol). Polymerization was performed under adiabatic condition, and the maximum temperature reached 85° C.

At the point in which the polymerization conversion rate reached 99%, 64 g of butadiene was added, followed by further polymerization for 1 minute, and then 6.2 g of 2-methyl-1-(3-(trimethoxysilyl)propyl)-4,5-dihydro-1H-imidazole was added, followed by reaction for 15 minutes.

Subsequently, the reaction solution was heated to 80° C. or higher to introduce hydrogen into the system. Then 2.05 g of [bis(η5-cyclopentadienyl)titanium(furfuryloxy)chloride], 3.51 g of diethylaluminum chloride, and 0.86 g of n-butyllithium were added and the reaction solution was reacted while keeping the hydrogen pressure 0.7 MPa or more. After reaching a predetermined hydrogen cumulative flow rate, the reaction solution was returned to normal temperature and normal pressure, and the reaction solution was withdrawn from the reaction vessel to obtain a polymer solution.

Thereafter, hydrogenation reaction and desolvation were carried out by the same operation as in Example 1, and drying was carried out with a hot roll adjusted to 110° C. to obtain hydrogenated conjugated diene polymer G. The polymerization formulation of the obtained hydrogenated conjugated diene polymer G is shown in the following Table 1, and various material properties and the like are shown in the following Table 2.

### (2) Production and Evaluation of Crosslinked Polymer

A polymer composition and a crosslinked polymer were produced in the same manner as in Example 1 except that the hydrogenated conjugated diene polymer A was replaced with the hydrogenated conjugated diene polymer G Further, material properties were evaluated in the same manner as in Example 1 for the obtained crosslinked polymer. The measurement results are shown in the following Table 2.

### Examples 8 and 9

### (1) Production and Evaluation of Hydrogenated Conjugated Diene Polymers H and

Polymerization reaction, hydrogenation reaction, and desolvation were carried out by the same operation as in Example 3 except that the hydrogen cumulative flow rate was reduced in hydrogenation reaction, and then drying was carried out with a hot roll adjusted to 110° C. to obtain hydrogenated conjugated diene polymers H and I. The polymerization formulations of the obtained hydrogenated conjugated diene polymers H and I are shown in the following Table 1, and various material properties and the like are shown in the following Table 2.

### (2) Production and Evaluation of Crosslinked Polymer

Polymer compositions and crosslinked polymers were produced in the same manner as in Example 1 except that the hydrogenated conjugated diene polymer A was replaced with the hydrogenated conjugated diene polymers H or I. Further, material properties were evaluated in the same manner as in Example 1 for the obtained crosslinked polymers. The measurement results are shown in the following Table 2.

### Comparative Example 1

### (1) Production and Evaluation of Hydrogenated Conjugated Diene Polymer P

Polymerization reaction and desolvation were carried out by the same operation as in Example 1 except that hydrogenation reaction was not carried out, and then drying was carried out with a hot roll adjusted to 110° C. to obtain hydrogenated conjugated diene polymer P. The polymerization formulation of the obtained hydrogenated conjugated diene polymer P is shown in the following Table 1, and various material properties and the like are shown in the following Table 2.

### (2) Production and Evaluation of Crosslinked Polymer

A polymer composition and a crosslinked polymer were produced in the same manner as in Example 1 except that the hydrogenated conjugated diene polymer A was replaced with the hydrogenated conjugated diene polymer P. Further, material properties were evaluated in the same manner as in Example 1 for the obtained crosslinked polymer. The measurement results are shown in the following Table 2.

### Comparative Example 2

### (1) Production and Evaluation of Hydrogenated Conjugated Diene Polymer Q

Into a nitrogen-purged autoclave reactor having an internal volume of 50 L, 25600 g of cyclohexane, 179 g of tetrahydrofuran, 736 g of styrene, and 2400 g of 1,3-butadiene were charged. After the temperature of the contents in the reactor was adjusted to 45° C., polymerization was initiated by adding a cyclohexane solution including n-butyl lithium (69.94 mmol). Polymerization was performed under adiabatic condition, and the maximum temperature reached 85° C.

At the point in which the polymerization conversion rate reached 99%, 64 g of butadiene was added, followed by further polymerization for 1 minute, and then 2.24 g of silicon tetrachloride was added, followed by reaction for 15 minutes.

Subsequently, hydrogenation reaction and desolvation were carried out by the same operation as in Example 1, and drying was carried out with a hot roll adjusted to 110° C. to obtain hydrogenated conjugated diene polymer Q. The polymerization formulation of the obtained hydrogenated conjugated diene polymer Q is shown in the following Table 1, and various material properties and the like are shown in the following Table 2.

### (2) Production and Evaluation of Crosslinked Polymer

A polymer composition and a crosslinked polymer were produced in the same manner as in Example 1 except that the hydrogenated conjugated diene polymer A was replaced with the conjugated diene polymer Q. Further, material properties were evaluated in the same manner as in Example 1 for the obtained crosslinked polymer. The measurement results are shown in the following Table 2.

### Comparative Example 3

### (1) Production and Evaluation of Hydrogenated Conjugated Diene Polymer R

Polymerization reaction, hydrogenation reaction, and desolvation were carried out by the same operation as in Example 3 except that the hydrogen cumulative flow rate was reduced in hydrogenation reaction, and then drying was carried out with a hot roll adjusted to 110° C. to obtain hydrogenated conjugated diene polymer R. The polymerization formulation of the obtained hydrogenated conjugated diene polymer R is shown in the following Table 1, and various material properties and the like are shown in the following Table 2.

### (2) Production and Evaluation of Crosslinked Polymer

A polymer composition and a crosslinked polymer were produced in the same manner as in Example 1 except that the hydrogenated conjugated diene polymer A was replaced with the hydrogenated conjugated diene polymer R. Further, material properties were evaluated in the same manner as in Example 1 for the obtained crosslinked polymer. The measurement results are shown in the following Table 2.

TABLE 1

| | | | | | | | | | | | Com- | Com- | Com- |
|---|---|---|---|---|---|---|---|---|---|---|---|---|---|
| | | Exam- | Exam- | Exam- | Exam- | Exam- | Exam- | Exam- | Exam- | Exam- | parative | parative | parative |
| | | ple | ple | ple | ple | ple | ple | ple | ple | ple | Exam- | Exam- | Exam- |
| | | 1 | 2 | 3 | 4 | 5 | 6 | 7 | 8 | 9 | ple 1 | ple 2 | ple 3 |
| (Hydrogenated) | Conjugated | A | B | C | D | E | F | G | H | I | P | Q | R |
| diene polymer | | | | | | | | | | | | | |
| Polymerization | | | | | | | | | | | | | |
| Formulation | | | | | | | | | | | | | |
| Solvent | | | | | | | | | | | | | |
| :Cyclohexane | (g) | 25600 | 25600 | 25600 | 25600 | 25600 | 25600 | 25600 | 25600 | 25600 | 25600 | 25600 | 25600 |
| Vinyl content | | | | | | | | | | | | | |
| adjuster | | | | | | | | | | | | | |
| :Tetrahydrofuran | (g) | 179 | 179 | 179 | 179 | 179 | 179 | 179 | 179 | 179 | 179 | 179 | 179 |
| Polymerization | | | | | | | | | | | | | |
| monomer | | | | | | | | | | | | | |
| :Styrene | (g) | 960 | 1056 | 1088 | 1280 | 1088 | 1088 | 1088 | 1088 | 1088 | 960 | 736 | 1088 |
| :Butadiene | (g) | 2176 | 2080 | 2048 | 1856 | 2048 | 2048 | 2048 | 2048 | 2048 | 2176 | 2400 | 2048 |
| :Additionally added | (g) | 64 | 64 | 64 | 64 | 64 | 64 | 64 | 64 | 64 | 64 | 64 | 64 |
| butadiene | | | | | | | | | | | | | |
| Polymerization | | | | | | | | | | | | | |
| initiator | | | | | | | | | | | | | |
| :n-butyl lithium | (mmol) | 69.94 | 67.94 | 67.94 | 64.94 | 33.97 | 33.97 | 33.97 | 67.94 | 67.94 | 69.94 | 69.94 | 67.94 |
| Coupling agent | | | | | | | | | | | | | |
| :Silicon | (g) | 2.24 | 2.18 | 2.18 | 2.11 | — | — | — | 2.18 | 2.18 | 2.24 | 2.24 | 2.18 |
| tetrachloride | | | | | | | | | | | | | |
| Amine modifier | | | | | | | | | | | | | |
| :N-Si-1 *1 | (g) | — | — | — | — | 5.6 | — | — | — | — | — | — | — |
| :N-Si-2 *2 | (g) | — | — | — | — | — | 8.5 | — | — | — | — | — | — |
| :N-Si-3 *3 | (g) | — | — | — | — | — | — | 6.2 | — | — | — | — | — |

*1: N,N-dimethylaminopropylmethyldiethoxysilane
*2: N,N-bis(trimethylsilyl)aminopropylmethyldiethoxysilane
*3: 2-methyl-1-(3-(trimethoxysilyl)propyl)-4,5-dihydro-1H-imidazole

TABLE 2

| | | | | | | | | | | Comparative | | |
|---|---|---|---|---|---|---|---|---|---|---|---|---|
| | Example | | | | | | | | | Example | | |
| | 1 | 2 | 3 | 4 | 5 | 6 | 7 | 8 | 9 | 1 | 2 | 3 |
| Bonded styrene content (wt %) | 30 | 33 | 34 | 40 | 34 | 33 | 33 | 34 | 34 | 30 | 23 | 34 |
| Vinyl bond content (mol %) | 50 | 50 | 49 | 48 | 51 | 50 | 51 | 49 | 49 | 48 | 51 | 50 |
| Hydrogenation rate (%) | 95 | 95 | 91 | 97 | 94 | 94 | 94 | 81 | 85 | 0 | 95 | 70 |
| 1^{st} peak weight-average molecular | 10 | 10 | 10 | 11 | 20 | 19 | 19 | 10 | 10 | 10 | 10 | 10 |
| weight (1 × 10⁴) | | | | | | | | | | | | |
| TB (MPa) | 24 | 26 | 27 | 27 | 28 | 30 | 31 | 22 | 24 | 14 | 21 | 19 |
| EB (%) | 460 | 450 | 440 | 470 | 470 | 460 | 450 | 380 | 420 | 260 | 460 | 330 |
| Abrasion resistance (index) | 105 | 107 | 110 | 108 | 124 | 136 | 130 | 104 | 106 | 100 | 98 | 102 |
| Wet grip performance (index) | 95 | 107 | 108 | 112 | 135 | 140 | 138 | 104 | 106 | 100 | 70 | 102 |

TABLE 3

| Blending formulation (phr) | |
|---|---|
| (Hydrogenated) Conjugated diene polymer | 100 |
| Silica *1) | 45 |
| Silane coupling agent *2) | 3.6 |
| Stearic acid | 2.0 |
| Antioxidant *3) | 1.0 |
| Zinc oxide | 3.0 |
| Vulcanization accelerator CZ *4) | 1.8 |
| Vulcanization accelerator D *5) | 1.5 |
| Sulfur | 1.5 |

*1) ZEOSIL 1165 MP manufactured by Solvay S.A.
*2) Si 75 manufactured by Evonik industries AG
*3) Nocrac 810NA manufactured by Ouchi Shinko Chemical Industrial Co., Ltd.
*4) Nocceler CZ manufactured by Ouchi Shinko Chemical Industrial Co., Ltd.
*5) Nocceler D manufactured by Ouchi Shinko Chemical Industrial Co., Ltd.

As apparently shown from Table 2, the crosslinked polymers obtained by using the hydrogenated conjugated diene polymer of the present disclosure in which the structural unit derived from an aromatic vinyl compound is 30 mass % or more with respect to the entire structural units derived from monomers of the polymer and the hydrogenation rate of the structural unit derived from butadiene is 80% to 99%, exhibited sufficiently improved mechanical strength and abrasion resistance of the material, as well as excellent processability. Further, Examples 2 to 7 and 9 also showed satisfactory wet grip performance, and in particular, Examples 2 to 7 in which the hydrogenation rate is 91% or more exhibited extremely well-balanced mechanical strength, abrasion resistance, and wet grip characteristics.

1. A hydrogenated conjugated diene polymer, comprising:
a structural unit derived from a conjugated diene compound; and
a structural unit derived from an aromatic vinyl compound,
wherein an amount of the structural unit derived from the aromatic vinyl compound is 30 mass % or more with respect to entire structural units derived from monomers of the polymer, and
wherein when composition ratios of a structural unit represented by Formula (3), a structural unit represented by Formula (4), a structural unit represented by Formula (5), and a structural unit represented by Formula (6) are represented by p, q, r, and s, respectively, Expression (A) is satisfied:

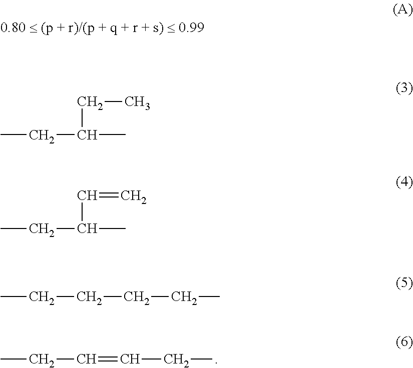

2. A hydrogenated conjugated diene polymer, comprising:
a structural unit derived from a conjugated diene compound; and
a structural unit derived from an aromatic vinyl compound,
wherein the conjugated diene compound includes butadiene, an amount of the structural unit derived from the aromatic vinyl compound is 30 mass % or more with respect to entire structural units derived from monomers of the polymer, and a hydrogenation rate of the structural unit derived from butadiene is 80% to 99%.

3. The hydrogenated conjugated diene polymer according to claim 1, comprising, at a polymer terminal, one or more functional groups selected from the group consisting of an amino group, a group having a carbon-nitrogen double bond, a nitrogen-containing heterocyclic group, a phosphino group, a thiol group, and a hydrocarbyloxysilyl group.

4. The hydrogenated conjugated diene polymer according to claim 1, comprising a block consisting of the structural unit derived from the conjugated diene compound.

5. A method of producing a hydrogenated conjugated diene polymer, the method comprising: hydrogenating a conjugated diene polymer comprising a structural unit derived from a conjugated diene compound and a structural unit derived from an aromatic vinyl compound, wherein the conjugated diene compound includes butadiene, and an amount of the structural unit derived from the aromatic vinyl compound is 30 mass % or more with respect to entire structural units derived from monomers of the polymer,
wherein the conjugated diene polymer is hydrogenated such that a hydrogenation rate of the structural unit derived from butadiene is 80% to 99%.

6. A polymer composition, comprising:
the hydrogenated conjugated diene polymer according to claim 1; and
a crosslinking agent.

7. A crosslinked polymer, obtained by crosslinking the polymer composition according to claim 6.

8. A tire, comprising the crosslinked polymer according to claim 7 as a material for at least a tread or a side wall.

9. The hydrogenated conjugated diene polymer according to claim 2, comprising, at a polymer terminal, one or more functional groups selected from the group consisting of an amino group, a group having a carbon-nitrogen double bond, a nitrogen-containing heterocyclic group, a phosphino group, a thiol group, and a hydrocarbyloxysilyl group.

10. The hydrogenated conjugated diene polymer according to claim 2, comprising a block consisting of the structural unit derived from the conjugated diene compound.

11. A polymer composition, comprising:
the hydrogenated conjugated diene polymer according to claim 2; and
a crosslinking agent.

12. A crosslinked polymer, obtained by crosslinking the polymer composition according to claim 11.

13. A tire, comprising the crosslinked polymer according to claim 12 as a material for at least a tread or a side wall.

14. A polymer composition, comprising:
a hydrogenated conjugated diene polymer obtained by the method according to claim 5; and
a crosslinking agent.

15. A crosslinked polymer, obtained by crosslinking the polymer composition according to claim 14.

16. A tire, comprising the crosslinked polymer according to claim 15 as a material for at least a tread or a side wall.
